(19) United States
(12) Patent Application Publication
(10) Pub. No.: US 2006/0111131 A1
(43) Pub. Date: May 25, 2006

(54) Short message service (SMS) remote control for mobile station

(75) Inventors: Sang-Cheol Shin, Gyeonggi-Do (KR); Kyung-Hoon Kimi, Seoul (KR); Jong-Cheol Jung, Seoul (KR); Young-Ho Jung, Seoul (KR)

Correspondence Address: JONATHAN Y. KANG, ESQ.;LEE, HONG, DEGERMAN, KANG & SCHMADEKA, P.C., 14 Floor, 801 S. Figueroa Street, Los Angeles, CA, 90017-5554, US

(73) Assignee: LG Electronics Inc.

(21) Appl. No.: 11/286,871

(22) Filed: Nov. 22, 2005

(30) Foreign Application Priority Data
Nov. 22, 2004 (KR) 95932/2004

(51) Int. Cl. H04Q 7/20

(52) U.S. Cl. 455/466

(57) ABSTRACT

In one embodiment, a short message service (SMS) remote control for a mobile station comprises receiving a SMS message at a first mobile station in a first area, the SMS message received from a server via a communication network. The method also comprises transmitting the SMS message from the first mobile station to a second mobile station via SMS communication. The method also comprises transmitting the SMS message received by the second mobile station via the SMS communication to the server via the communication network. The communication network may comprise the Internet.

### CROSS-REFERENCE TO RELATED APPLICATIONS

Pursuant to 35 U.S.C. § 119(a), this application claims the benefit of earlier filing date and right of priority to Korean Application No. 2004-0095932, filed on Nov. 22, 2004, the contents of which are hereby incorporated by reference herein in their entirety.

### FIELD OF THE INVENTION

The present invention relates generally to a mobile station and, more particularly, to short message service (SMS) in a mobile station.

### BACKGROUND OF THE INVENTION

Before selling mobile stations, mobile station manufacturers perform a field test to determine whether the mobile stations operate normally under different operational standards. Testing of mobile stations for export which include Short Message Service (SMS) capabilities is especially difficult because of differences between communication networks (for example, US vs. Korean communication networks), as well as differences between SMSs of various wireless communications providers.

Therefore, SMS developers must perform SMS testing in multiple countries by sending and receiving SMS test messages through the mobile station. Thus, simplified SMS test procedures are needed.

### SUMMARY OF THE INVENTION

Accordingly, the present invention is directed to short message service (SMS) remote control for a mobile station that substantially obviates one or more problems due to limitations and disadvantages of the related art.

An object of the present invention is to provide for SMS remote control for a mobile station to enable a user to check whether the SMS of the mobile station is performed normally, by controlling the SMS from a remote location, such as via the Internet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a short message service (SMS) remote control method for a mobile station comprises receiving a SMS message at a first mobile station in a first area, the SMS message received from a server via a communication network. The method also comprises transmitting the SMS message from the first mobile station to a second mobile station via SMS communication. The method also comprises transmitting the SMS message received by the second mobile station via the SMS communication to the server via the communication network.

The communication network may comprise the Internet. The SMS message may be a SMS test message. The second mobile station may be located in the first area. Alternatively, the second mobile station may be located in a second area and the server may be located in a third area, where the first area and the third area are operated under different SMS standards.

In another embodiment, a short message service (SMS) remote control method for a mobile station comprises transmitting a SMS message from a server to a first mobile station in a first area via a communication network, wherein the SMS message received from the server is transmitted from the first mobile station to a second mobile station via SMS communication. The method also comprises receiving the SMS message received by the second mobile station via the SMS communication at the server via the communication network. The method may further comprise, in the server, comparing the SMS message transmitted to the first mobile station via the communication network against the SMS message received from the second mobile station via the communication network.

The transmitting of the SMS message to the first mobile station in the first area via the communication network may further comprise transmitting the SMS message to a client system connected to the communication network through a server system connected to the communication network, and transmitting the SMS message transmitted to the client system to the first mobile station connected to the client system. The first mobile station may receive the SMS message through a first virtual comport of the client system and transmit the received SMS message to the second mobile station through a SMS call. The second mobile station may transmit the SMS message transmitted through the SMS call to a second virtual comport of the client system. The server system may convert the SMS message written by a user into a serial communication data, and convert the serial communication data into a TCP/IP data and transmits the TCP/IP data to the client system via the communication network. The client system may convert the TCP/IP data into the serial communication data, transmit the serial communication data to the second mobile station, convert the serial communication data received from the second mobile station into a TCP/IP data and transmit the TCP/IP data to the server system via the communication network.

The SMS message transmitted to the first mobile station via the communication network may contain a message inputted by a user and a phone number of the second mobile station. The first mobile station may transmit the SMS message to the second mobile station via the SMS communication based on the phone number of the second mobile station. The SMS message transmitted to the second mobile station via the SMS communication may contain the message inputted by the user and a phone number of the first mobile station.

In yet another embodiment, a short message service (SMS) remote control system for a mobile station comprises a server system adapted to transmit a SMS message via the Internet. The system also comprises a client system connected to the server system via the Internet, adapted to transmit the SMS message received from the server system via the Internet to a first mobile station and to transmit the SMS message received by the server system via the Internet from a second mobile station. The SMS message is transmitted from the first mobile station to the second mobile station via SMS communication.

The server system may display the SMS message received from the client system on a display screen. The server system may also display the SMS message transmitted to the first mobile station and the SMS message received by the second mobile station on the display screen through a SMS test tool.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a diagram illustrating a system for remotely controlling a short message service (SMS) of a mobile station, according to an embodiment of the present invention.

FIG. 2 is a diagram illustrating a display screen for a SMS test tool installed on a server system, according to an embodiment of the present invention.

FIG. 3 is a flow diagram illustrating a method for transmitting a SMS message to a client system from a server system using the SMS remote control system, according to an embodiment of the present invention.

FIG. 4 is a flow diagram illustrating a method for transmitting a SMS message to the server system from the client system using the SMS remote control system, according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Remote control for short message service (SMS) for a mobile station is described. The remote control enables, for example, a SMS developer in a country operating according to a first SMS standard (e.g., US) to check whether the SMS of the mobile station located in a country operating according to a second SMS standard (e.g., Korea) is being performed normally by sending and/or receiving SMS messages by remote control. The sending and/or receiving of the SMS message may be performed via the Internet, for example.

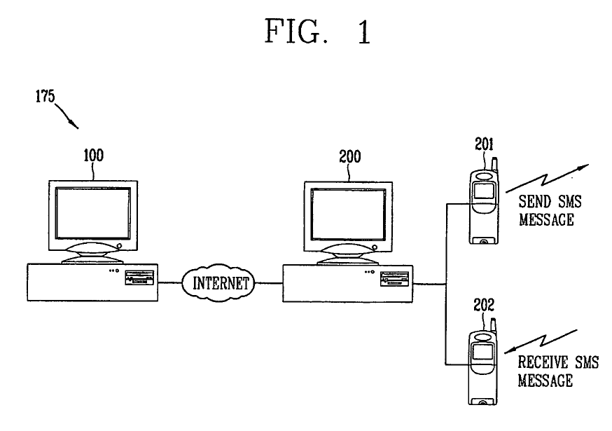

FIG. 1 is a diagram illustrating a system 175 for remotely controlling a short message service (SMS) of a mobile station, according to an embodiment of the present invention.

Referring to FIG. 1, the system 175 for remotely controlling a short message service (SMS) of a mobile station includes a server system (e.g., server personal computer (server PC)) 100 for transmitting a SMS message (e.g., a SMS test message) inputted by a SMS developer through a SMS test tool (e.g., a SMS test program) via the Internet and displaying the SMS message transmitted via the Internet. The system 175 also includes a client system (e.g., a client PC) 200, connected to the server system 100 via the Internet, for transmitting the SMS message received from the server system 100 via the Internet to a sending mobile station 201 and for transmitting the SMS message received from a receiving mobile station 202 to the server system 100 via the Internet.

The sending mobile station 201, connected to the client system 200, transmits the SMS message received from the client system 200 to the receiving mobile station 202 via a wireless communication network, for example. The receiving mobile station 202, connected to the client system 200, receives the SMS message from the sending mobile station 201 via the wireless communication network and transmits the received SMS message to the client system 200. The client system 200 then transmits the SMS message received from the receiving mobile station 202 to the server system 100 via the Internet. The sending mobile station 201 and the receiving mobile station 202 may be directly connected to the client system 200, for example, through two virtual communication ports (comports) of the client system 200 for SMS testing.

Operation of the system 175 is described in detail below. The server system 100 converts a SMS message (e.g., a SMS test message) inputted by a SMS developer to serial communication data. The serial communication data is converted into TCP/IP (transmission control protocol/internet protocol) data. The TCP/IP data is transmitted to the client system 200 via the Internet. The server system 100 may preferably operate to transmit the serial communication data to a virtual comport and convert the serial communication data transmitted through the virtual comport to the TCP/IP data. The client system 200 converts the TCP/IP data received from the server system 100 to serial communication data, and transmits the serial communication data to the sending mobile station 201. The sending mobile station 201 transmits the SMS message contained in the serial communication data received from the client system 200 to the receiving mobile station 202 via a wireless communications network. For example, the sending mobile station 201 may transmit the SMS message to the receiving mobile station 202 through a SMS call.

The receiving mobile station 202 then receives the SMS message transmitted through the SMS call, and transmits the received SMS message to the client system 200. For example, the receiving mobile station 202 converts the received SMS message to serial communication data, and transmits the serial communication data to the client system 200 through serial data communication. The client system 200 receives the serial communication data from the receiving mobile station 202, through a virtual comport for example, converts the received serial communication data to TCP/IP data, and transmits the TCP/IP data to the server system 100 via the Internet. The server system 100 converts the TCP/IP data received from the client system 200 to serial communication data, and displays a SMS message contained in the serial communication data on a display screen. The server system 100 may preferably receive the SMS message through a virtual comport, and display the received SMS message on the display screen using a SMS test tool. Subsequently, the SMS developer may perform a SMS test remotely.

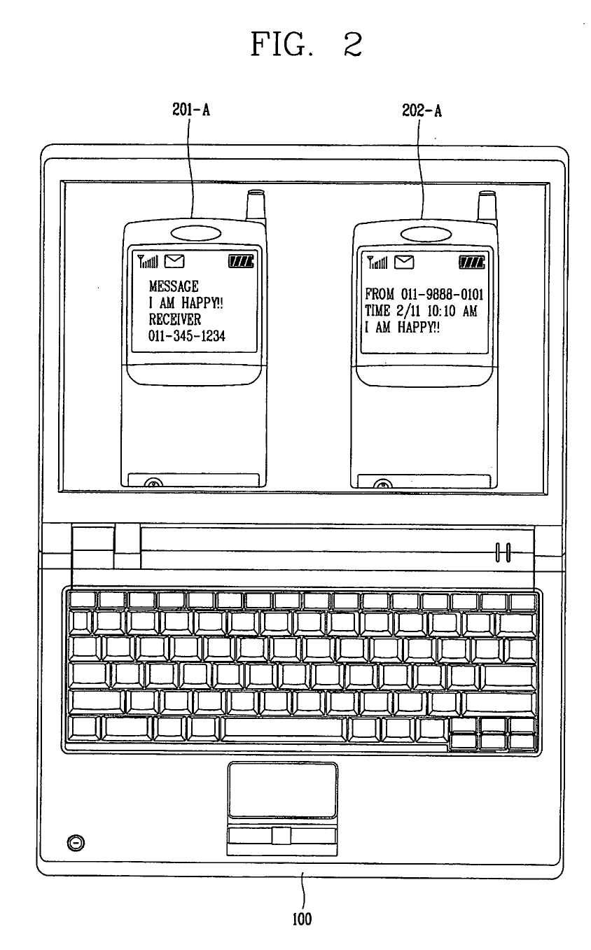

FIG. 2 is a diagram illustrating a display screen for a SMS test tool installed on a server system, according to an embodiment of the present invention.

Referring to FIG. 2, a virtual image 201-A of the sending mobile station 201 and a virtual image 202-A of the receiving mobile station 202 are displayed on the display screen of the SMS test tool. Thus, the SMS developer may enter a SMS message containing a receiver phone number and a message desired to be sent through the displayed sending mobile station 201-A. The SMS developer may then check the information of the SMS message received by the receiving mobile station 202 through the displayed receiving mobile station 202-A. The SMS message of the receiving mobile station 202 transmitted to the server system 100 contains information displayed on the display screen of the receiving mobile station 202, such as a sender phone number and a message reception time, as well as a message written by the SMS developer, such as “I am Happy!!”, as shown in FIG. 2.

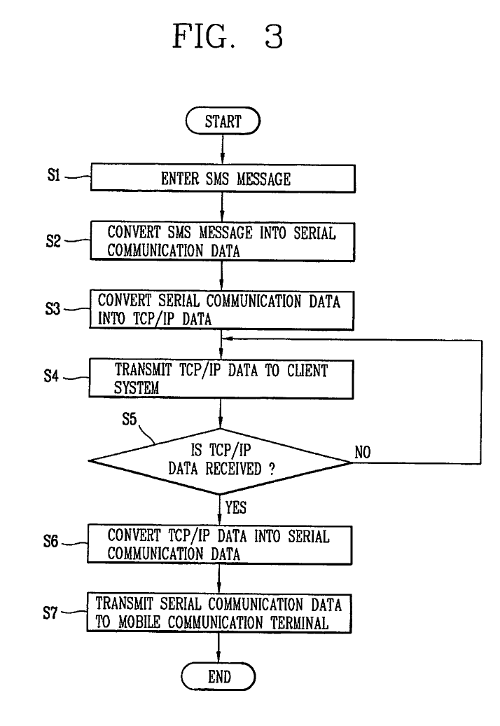

FIG. 3 is a flow diagram illustrating a method for transmitting a SMS message to a client system from a server system using the SMS remote control system, according to an embodiment of the present invention.

Referring to FIG. 3, the SMS developer enters a SMS message containing a message to be sent and a receiver phone number (e.g., a phone number of the receiving mobile station 202) through a SMS test tool installed on the server system 100 (S1). The server system 100 then converts the SMS message containing the message to be sent and the receiver phone number into serial communication data, and transmits the serial communication data to a virtual comport (S2).

The server system 100 allocates resources (e.g., IP resources or IP) of the client system 200 to the serial communication data received at the virtual comport, and converts the IP-allocated serial communication data to TCP/IP data (S3). The server system 100 then transmits the TCP/IP data to the client system 200 via the Internet (S4).

The client system 200 then receives the TCP/IP data (S5), and converts the received TCP/IP data into a serial communication data (S6). The client system 200 then transmits the serial communication data to the sending mobile station 201, such as through a virtual comport (S7). The sending mobile station 201 then sends the SMS message contained in the serial communication data to the receiving mobile station 202 corresponding to the receiver phone number contained in the SMS message via a wireless communication network.

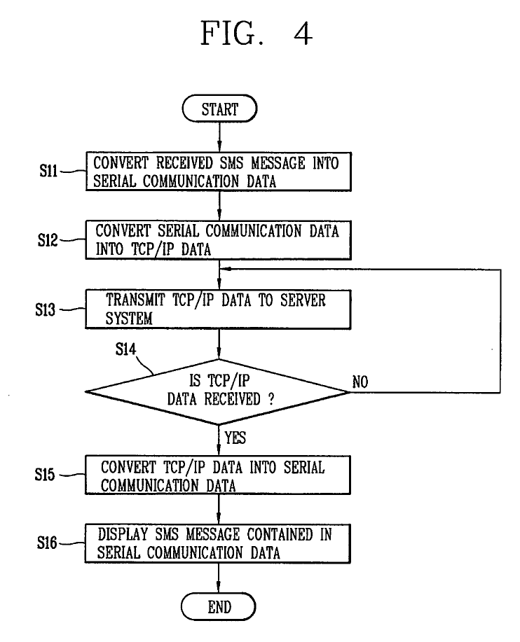

FIG. 4 is a flow diagram illustrating a method for transmitting a SMS message to the server system from the client system using the SMS remote control system, according to an embodiment of the present invention.

Referring to FIG. 4, the receiving mobile station 202 receives the SMS message via the wireless communication network, converts the received SMS message to serial communication data, and transmits the serial communication data to the client system 200 via the virtual comport. The client system 200 then allocates the IP of the server system 100 to the serial communication data received from the receiving mobile station 202, converts the IP-allocated serial communication data to TCP/IP data (S12), and transmits the TCP/IP data to the server system via the Internet (S13). When the TCP/IP data is received from the client system via the Internet (S14), the server system 100 converts the received TCP/IP data to serial communication data (S15), and displays the SMS message contained in the serial communication data on the display screen through a SMS test tool (S16). Consequently, the SMS developer may check whether the SMS is normally performed remotely, that is, without traveling to another country for the testing.

In one embodiment, a short message service (SMS) remote control method for a mobile station comprises receiving a SMS message at a first mobile station in a first area, the SMS message received from a server via a communication network. The method also comprises transmitting the SMS message from the first mobile station to a second mobile station via SMS communication. The method also comprises transmitting the SMS message received by the second mobile station via the SMS communication to the server via the communication network.

The communication network may comprise the Internet. The SMS message may be a SMS test message. The second mobile station may be located in the first area. Alternatively, the second mobile station may be located in a second area and the server may be located in a third area, where the first area and the third area are operated under different SMS standards.

In another embodiment, a short message service (SMS) remote control method for a mobile station comprises transmitting a SMS message from a server to a first mobile station in a first area via a communication network, wherein the SMS message received from the server is transmitted from the first mobile station to a second mobile station via SMS communication. The method also comprises receiving the SMS message received by the second mobile station via the SMS communication at the server via the communication network. The method may further comprise, in the server, comparing the SMS message transmitted to the first mobile station via the communication network against the SMS message received from the second mobile station via the communication network.

The transmitting of the SMS message to the first mobile station in the first area via the communication network may further comprise transmitting the SMS message to a client system connected to the communication network through a server system connected to the communication network, and transmitting the SMS message transmitted to the client system to the first mobile station connected to the client system. The first mobile station may receive the SMS message through a first virtual comport of the client system and transmit the received SMS message to the second mobile station through a SMS call. The second mobile station may transmit the SMS message transmitted through the SMS call to a second virtual comport of the client system. The server system may convert the SMS message written by a user into a serial communication data, and convert the serial communication data into a TCP/IP data and transmits the TCP/IP data to the client system via the communication network. The client system may convert the TCP/IP data into the serial communication data, transmit the serial communication data to the second mobile station, convert the serial communication data received from the second mobile station into a TCP/IP data and transmit the TCP/IP data to the server system via the communication network.

The SMS message transmitted to the first mobile station via the communication network may contain a message inputted by a user and a phone number of the second mobile station. The first mobile station may transmit the SMS message to the second mobile station via the SMS communication based on the phone number of the second mobile station. The SMS message transmitted to the second mobile station via the SMS communication may contain the message inputted by the user and a phone number of the first mobile station.

In yet another embodiment, a short message service (SMS) remote control system for a mobile station comprises a server system adapted to transmit a SMS message via the Internet. The system also comprises a client system connected to the server system via the Internet, adapted to transmit the SMS message received from the server system via the Internet to a first mobile station and to transmit the SMS message received by the server system via the Internet from a second mobile station. The SMS message is transmitted from the first mobile station to the second mobile station via SMS communication.

The server system may display the SMS message received from the client system on a display screen. The server system may also display the SMS message transmitted to the first mobile station and the SMS message received by the second mobile station on the display screen through a SMS test tool.

The present invention enables remote control of SMS to allow SMS testing under operational standards of different countries, without requiring test personnel to be physically located in the different countries.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A short message service (SMS) remote control method for a mobile station, the method comprising:
receiving a SMS message at a first mobile station in a first area, the SMS message received from a server via a communication network;
transmitting the SMS message from the first mobile station to a second mobile station via SMS communication; and
transmitting the SMS message received by the second mobile station via the SMS communication to the server via the communication network.

2. The method of claim 1, wherein the communication network comprises the Internet.

3. The method of claim 1, wherein the SMS message is a SMS test message.

4. The method of claim 1, wherein the second mobile station is located in the first area.

5. The method of claim 5, wherein the second mobile station is located in a second area.

6. The method of claim 1, wherein the server is located in a third area.

7. The method of claim 6, wherein the first area and the third area are operated under different SMS standards.

8. A short message service (SMS) remote control method for a mobile station, the method comprising:
transmitting a SMS message from a server to a first mobile station in a first area via a communication network, wherein the SMS message received from the server is transmitted from the first mobile station to a second mobile station via SMS communication; and
receiving the SMS message received by the second mobile station via the SMS communication at the server via the communication network.

9. The method of claim 8, wherein the communication network comprises the Internet.

10. The method of claim 8, wherein the SMS message is a SMS test message.

11. The method of claim 8, further comprising, in the server:
comparing the SMS message transmitted to the first mobile station via the communication network against the SMS message received from the second mobile station via the communication network.

12. The method of claim 8, wherein the second mobile station is located in the first area.

13. The method of claim 8, wherein the second mobile station is located in a second area.

14. The method of claim 13, wherein the server is located in a third area.

15. The method of claim 14, wherein the first area and the third area are operated under different SMS standards.

16. The method of claim 8, wherein the transmitting of the SMS message to the first mobile station in the first area via the communication network further comprises:
transmitting the SMS message to a client system connected to the communication network through a server system connected to the communication network; and
transmitting the SMS message transmitted to the client system to the first mobile station connected to the client system.

17. The method of claim 16, wherein the first mobile station receives the SMS message through a first virtual comport of the client system and transmits the received SMS message to the second mobile station through a SMS call, and
the second mobile station transmits the SMS message transmitted through the SMS call to a second virtual comport of the client system.

18. The method of claim 17, wherein the server system converts the SMS message written by a user into a serial communication data, converts the serial communication data into a TCP/IP data and transmits the TCP/IP data to the client system via the communication network, and
the client system converts the TCP/IP data into the serial communication data, transmits the serial communication data to the second mobile station, converts the serial communication data received from the second mobile station into a TCP/IP data and transmits the TCP/IP data to the server system via the communication network.

19. The method of claim 8, wherein the SMS message transmitted to the first mobile station via the communication network contains a message inputted by a user and a phone number of the second mobile station, and
wherein the first mobile station transmits the SMS message to the second mobile station via the SMS communication based on the phone number of the second mobile station.

20. The method of claim 19, wherein the SMS message transmitted to the second mobile station via the SMS communication contains the message inputted by the user and a phone number of the first mobile station.

21. A short message service (SMS) remote control system for a mobile station, comprising:
a server system adapted to transmit a SMS message via the Internet; and
a client system connected to the server system via the Internet, adapted to transmit the SMS message received from the server system via the Internet to a first mobile station and to transmit the SMS message received by the server system via the Internet from a second mobile station,
wherein the SMS message is transmitted from the first mobile station to the second mobile station via SMS communication.

22. The system of claim 21, wherein the server system displays the SMS message received from the client system on a display screen.

23. The system of claim 21, wherein the SMS message is a SMS test message.

24. The system of claim 22, wherein the server system displays the SMS message transmitted to the first mobile station and the SMS message received by the second mobile station on the display screen through a SMS test tool.
